(19) United States
(12) Patent Application Publication
(10) Pub. No.: US 2006/0055644 A1
(43) Pub. Date: Mar. 16, 2006

(54) TDC panel driver and its driving method for reducing flickers on display panel

(76) Inventors: Beom-Seon Ryu, Chungcheongbuk-do (KR); Soon-Teak Oh, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/223,390

(22) Filed: Sep. 8, 2005

(30) Foreign Application Priority Data
Sep. 10, 2004 (KR) 2004-0072719

(51) Int. Cl. G09G 3/32

(52) U.S. Cl. 345/83

(57) ABSTRACT

The present invention provides a time division controlled (TDC) panel driver for reducing flickers. The TDC panel driver includes an address counter for counting a pixel address of a line corresponding to a predetermined resolution of a TDC panel to thereby output a counting value; a timing generating block for comparing the counting value and a predetermined order value to thereby output a read start signal; a timing controller for generating a line address in response to the read start signal and outputting a memory read control signal; and a memory for performing a memory read and a memory write operations, wherein a start timing for the memory read operation of the memory is controlled by the memory read control signal.

### FIELD OF INVENTION

The present invention relates to a time division controlled (TDC) panel driver and its driving method for controlling memory read and memory write timings; and, more particularly, to a 2-field TDC panel driver and its driving method for controlling a memory read timing according to a resolution of a display panel to thereby reduce flickers generated on the display panel.

### DESCRIPTION OF PRIOR ART

Currently, a small-sized display device for displaying an image with a high resolution, i.e., a high pixel per inch (PPI) is required. In order to satisfy above requirement, an n-field time division controlled (TDC) panel driver is used for the small-sized display device. The n-field TDC panel driver can make the small-sized display device improve an aperture ratio to thereby display an image with high resolution. Herein, n is a natural number which is bigger than 2.

FIG. 1 is a block diagram describing a conventional 3-field TDC display panel.

As shown, each pixel included in the conventional display panel is provided with a plurality of sub-pixels. Each of the sub-pixels includes one of light-emitting diodes (LED) 12_1, 12_2, and 12_3 and one driver 14. The driver 14 includes a compensating block 14A for compensating a threshold voltage of a thin-film transistor (TFT). Further, each of the sub-pixels receives a first data DATA_R[l], a second data DATA_G[l], and a third data DATA_B[l], respectively. A select signal SELECT[m] is inputted to all of the sub-pixels.

FIG. 2 is a waveform demonstrating the operation timing of the conventional display panel shown in FIG. 1.

In FIG. 2, V_SYNC refers a vertical synchronization signal; and H_SYNC refers a horizontal synchronization signal. During one cycle of the vertical synchronization signal V_SYNC, one frame data is written or read. Further, during one cycle of the horizontal synchronization signal H_SYNC, one line data is written or read.

As shown in FIG. 2, the display panel assigns one output of the driver 14 to one sub-pixel. Thus, the driver 14 sequentially drives sub pixels by sequentially activating control signals G(1) to G(32) during one frame period. That is, during one frame period, the driver 14 in each sub-pixel is operated once based on each of the control signals G(1) to G(32) through each gate driver. Herein, the frame period refers where a data enable signal DATA_EN is activated. Also, the frame period is corresponded to a section where the vertical synchronization signal V_SYNC is activated into a logic level ‘H’.

FIG. 3 is a waveform demonstrating a memory read and a memory write timings of the conventional display panel shown in FIG. 1, having a 240×320 resolution, i.e., a quad video graphic array (QVGA).

Because the display panel has the 240×320 resolution, 320 lines are written or read during one cycle of the vertical synchronization signal V_SYNC. Meanwhile, as shown in FIG. 3, 336 cycles of the horizontal synchronization signal H_SYNC are included in one cycle of the vertical synchronization signal V_SYNC instead of 320 cycles of the horizontal synchronization signal H_SYNC. The surplus 16 cycles are line data separation margins. Therefore, one cycle of the vertical synchronization signal V_SYNC includes 320 cycles of the horizontal synchronization signal H_SYNC for 320 line data and 16 cycles of the horizontal synchronization signal H_SYNC for the line data separation margin.

Further, 240 pixel data are written or read during one cycle of the horizontal synchronization signal H_SYNC. If a Pth line data is written at a first period of the horizontal synchronization signal H_SYNC, a (P+1)th line data is written at a second period of the horizontal synchronization signal H_SYNC and, concurrently, Pth line is read and displayed to the display panel.

FIG. 4 is a diagram showing a relationship between a memory read line and a memory write line where the memory read and the memory write timings shown in FIGS. 3 is applied to the display panel shown in FIG. 1.

As shown in FIG. 4, a memory read frequency and a memory write frequency are the same as 60 Hz. The memory read is not started until two line-scan times 2H are passed after the memory write is started. A slope of a memory write line A is determined by a speed of the memory write performed by a CPU. Further, a slope of a memory read line B is determined by the line frequency which is automatically determined by a resolution and the frame frequency of the display panel. Referring to FIG. 4, the memory write line A and the memory read line B are not crossed each other at every time. This means that a flicker in not occurred on the display panel.

Meanwhile, a size of the compensating block 14A of the conventional 3-field TDC display panel is hard to be reduced. Therefore, a size of the LED 12 is reduced to thereby implement a small-sized display panel with a high resolution. Usually, when the size of the LED 12 is reduced, an aperture ratio is decreased. The aperture ratio refers a ratio of an area actually displaying an image to a total area of a display panel. Thus, when the size of the LED 12 is reduced, a performance of the display panel is degraded.

### SUMMARY OF INVENTION

It is, therefore, an object of the present invention to provide a 2-field time division controlled (TDC) panel driver and its driving method for reducing a flicker.

In accordance with an aspect of the present invention, there is provided a driving method for a TCD panel driver including the steps of: (a) counting a pixel address of a line corresponding to a predetermined resolution of a TDC panel to thereby output a counting value; (b) comparing the counting value and a predetermined order value to thereby output a read start signal; (c) generating a line address in response to the read start signal and outputting a memory read control signal; and (d) performing a memory read and a memory write operations, wherein a start timing for the memory read operation is controlled by the memory read control signal.

In accordance with another aspect of the present invention, there is provided a TCD panel driver including: an address counter for counting a pixel address of a line corresponding to a predetermined resolution of a TDC panel to thereby output a counting value; a timing generating block for comparing the counting value and a predetermined order value to thereby output a read start signal; a timing controller for generating a line address in response to the read start signal and outputting a memory read control signal; and a memory for performing a memory read and a memory write operations, wherein a start timing for the memory read operation of the memory is controlled by the memory read control signal.

### BRIEF DESCRIPTION OF THE DRAWINGS

The above and other objects and features of the present invention will become apparent from the following description of preferred embodiments taken in conjunction with the accompanying drawings, in which:

FIG. 1 is a block diagram describing a conventional 3-field TDC display panel;

FIG. 2 is a waveform demonstrating the operation timing of the conventional display panel shown in FIG. 1;

FIG. 3 is a waveform demonstrating a memory read and a memory write timings of the conventional display panel shown in FIG. 1, having a 240×320 resolution, i.e., a quad video graphic array (QVGA);

FIG. 4 is a diagram showing a relationship between a memory read line and a memory write line where the memory read and the memory write timings shown in FIGS. 3 is applied to the display panel shown in FIG. 1;

FIG. 5 is a block diagram showing a 3-field TDC panel having a quad video graphic array (QVGA), i.e., 240×320, and a 60 Hz frame frequency in accordance with a preferred embodiment of the present invention;

FIG. 6 is a waveform demonstrating the operation timing of the 2-field TDC panel having a quad video graphic array (QVGA), i.e., 240×320, and a 60 Hz frame frequency in accordance with another embodiment of the present invention;

FIG. 7 is a diagram showing a relationship between a memory write line and a memory read line where the memory read and the memory write timings shown in FIG. 3 is applied to the 2-field TDC panel shown in FIG. 6;

FIG. 8 is a block diagram describing a 2-field TDC panel driver for use in the 2-field TDC panel shown in FIG. 6;

FIGS. 9 and 10 are diagrams demonstrating the operation of the 2-field TDC panel driver shown in FIG. 8;

FIG. 11 is a diagram showing a relationship between the memory read line and memory write line where the memory read and the memory write timings shown in FIGS. 9 and 10 are applied to the 2-field TDC panel of the present invention.

### DETAILED DESCRIPTION OF INVENTION

Hereinafter, an n-field time division controlled (TDC) panel driver in accordance with the present invention will be described in detail referring to the accompanying drawings.

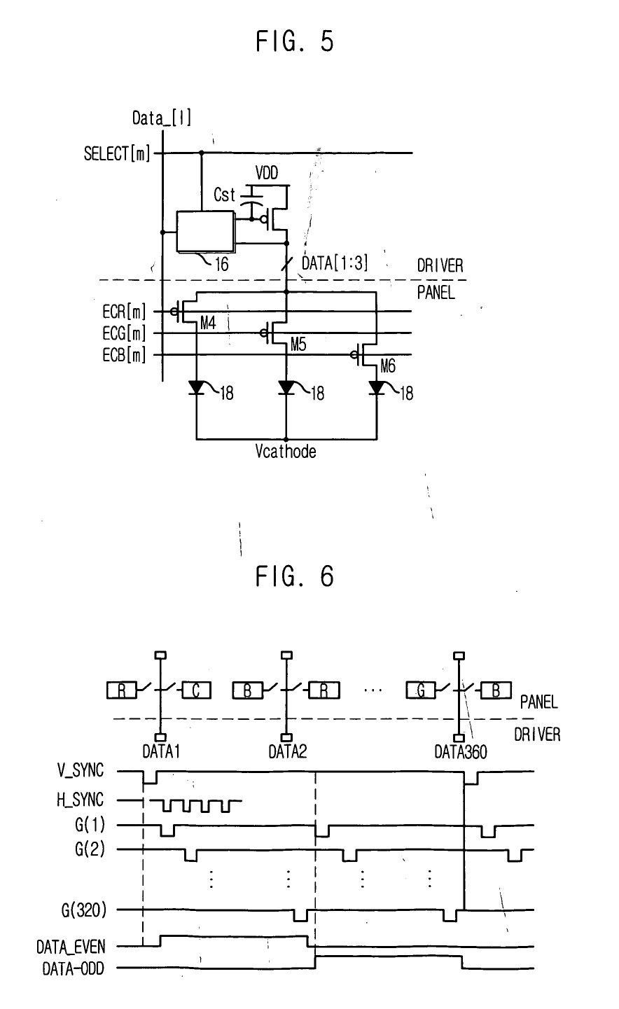

FIG. 5 is a block diagram showing a 3-field TDC panel having a quad video graphic array (QVGA), i.e., 240×320, and a 60 Hz frame frequency in accordance with a preferred embodiment of the present invention.

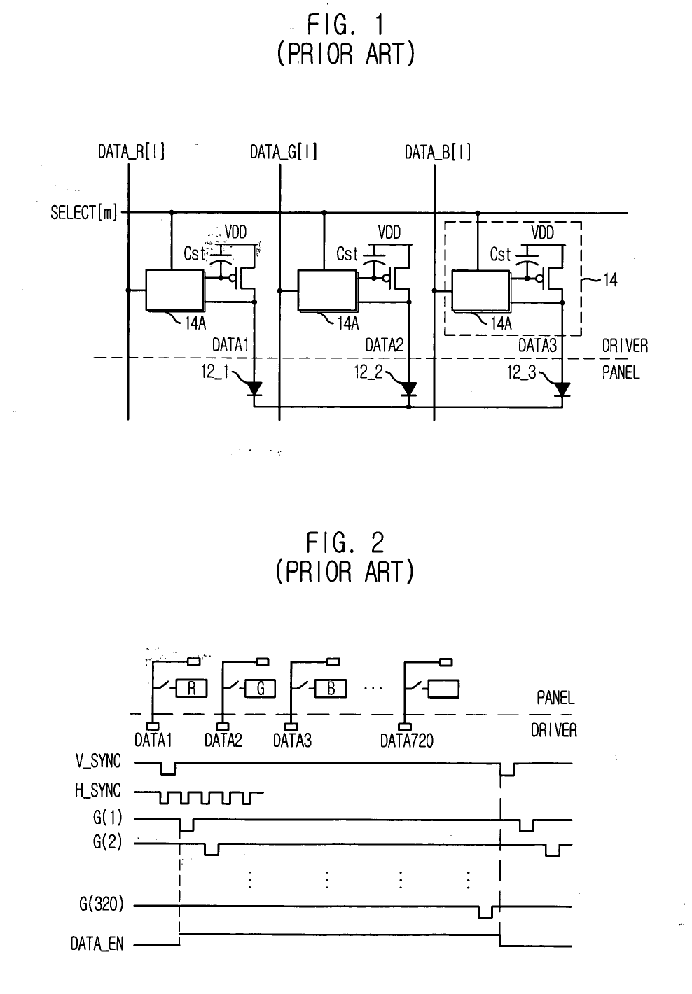

As shown, in the 3-field TDC panel, three sub-pixels share one driving block 16. That is, each pixel includes a common sub-pixel having one driving block 16 instead of a plurality of driving blocks 14 shown in FIG. 1. Therefore, a size of a LED 18 does not need to be reduced in order to implement a small-sized display device with a high resolution. That is, the aperture ratio is not decreased.

The 3-field TDC panel further includes a switching transistors M4, M5, and M6, each receiving three switching signals ECR[m], ECG[m], and ECB[m], and, as a result, an input data DATA[l]. A select signal SELECT[m] is inputted to the driving block 16 to thereby drives a sub-pixel corresponding to the input signal DATA[l].

In the abovementioned embodiment, the display panel of the present invention includes a plurality of pixels, each having three color sub-pixels of R, G, B-type sub-pixels for receiving the input data DATA[l]. Meanwhile, in another embodiment of the present invention, the number of sub-pixels included each pixel of the display panel can be varied.

FIG. 6 is a waveform demonstrating the operation timing of the 2-field TDC panel in accordance with another embodiment, including a pixel having two sub-pixels.

Herein, the 2-field TDC panel have a quad video graphic array (QVGA), i.e., 240×320, and a 60 Hz frame frequency.

As shown, one output of a driver of the 2-field TDC panel drives two sub-pixels. Thus, one frame is time-divided into an odd field and an even field. An odd data enable signal DATA_ODD and an even data enable signal DATA_EVEN are provided for the odd field and the even field, respectively. Depending on the status of the odd and even data enable signals DATA_ODD and DATA_EVEN, the output of the driver is connected or disconnected to two sub-pixels. That is, during the odd field, an odd sub-pixel receives a data; during the even field, an even sub-pixel receives a data.

Therefore, as compared with the conventional display device shown in FIG. 2, the 2-field TDC panel shown in FIG. 6 requires only half numbers of output of the driver. Further, a panel driving frequency of the 2-field TDC panel is higher than that of the conventional display device as much as twice.

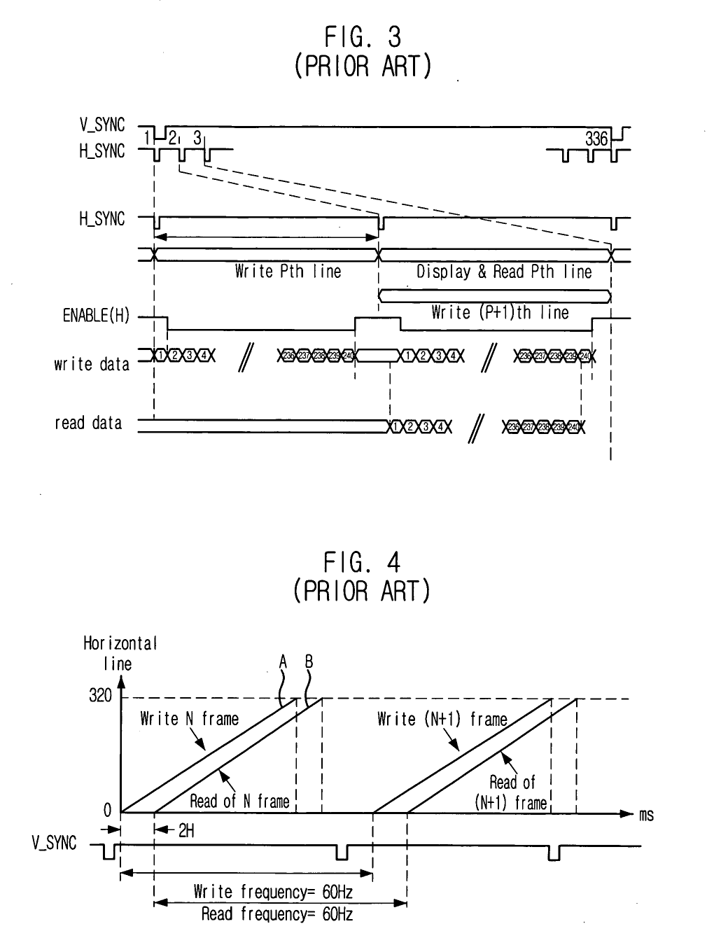

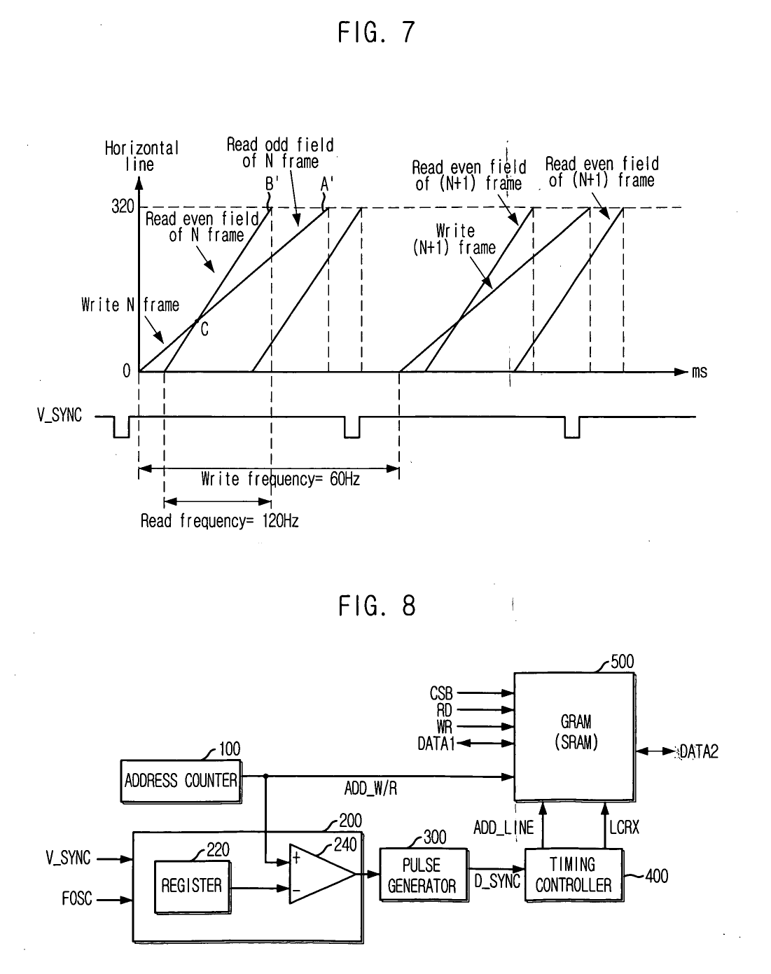

FIG. 7 is a diagram showing a relationship between a memory write line and a memory read line where the memory read and the memory write timings shown in FIG. 3 is applied to the 2-field TDC panel shown in FIG. 6.

As shown, a memory write frequency is 60 Hz; but a memory read frequency is 120 Hz. That is, while the memory write is performed one cycle, the memory reads are performed twice; one for the odd field and the other for the even field. Therefore, when the memory read and the memory write timings shown in FIG. 3 is applied to the 2-field TDC panel, a memory write line A′ and a memory read line B′ are crossed each other. Because the memory read frequency is twice than the memory write frequency, a slope of the memory read line B′ is increased and, therefore, the memory read line B′ is crossed with the memory write line A′. That is, since the memory write needs more operating time than the memory read, a new data is stored in a buffer memory before a previous data latched in the buffer memory is not outputted to the panel.

In this case, a flicker is occurred because the previous and the new data are mixed each other and, then, displayed on the display panel. For example, the Nth frame data and the (N+1)th frame data newly updated to the buffer memory through the memory write are concurrently displayed on the display panel after a cross point C shown in FIG. 7. The flicker causes serious degradation of showing an image; particularly, a moving picture having plural image frames up-dated frequently or inputted continuously.

FIG. 8 is a block diagram describing a 2-field TDC panel driver for use in the 2-field TDC panel shown in FIG. 6.

As shown, the 2-field TDC panel driver includes an address counter 100, a timing generator 200, a pulse generator 300, a timing controller 400, and a memory 500.

The address counter 100 counts the number of lines which is written to the memory 500 corresponding to a predetermined resolution of a 2-field TDC panel to thereby output a counting value to the timing generator 200 and the memory 500. In other words, the address counter 100 counts the number of horizontal synchronization signals H_SYNC from “1” to “320” while a vertical synchronization signal V_SYNC is activated. That is, if a fourth line of the frame is written to the memory 500, the counting value becomes “4”.

The timing generator 200 receives the vertical synchronization signal V_SYNC and a clock FOSC. Herein, the clock FOSC is an output signal from an oscillator in the 2-field TDC panel driver. Generally, the clock FOSC is a high frequency signal having a frequency of several MHz. The clock FOSC is divided in order to generate a line frequency of hundreds of Khz.

The timing generator 200 includes a register 220 and a comparator 240. The timing generator 200 stores an order value of the horizontal synchronization signal H_SYNC where the memory read is started. For example, because the display panel has a resolution of 240×320, the order value “161” is stored in the register 220. The order value “161” is refers a half value of “320”. The comparator 240 compares the counting value outputted from the address counter 100 and the order value. If the counting value is bigger than the order value, the comparator outputs a comparison output to the pulse generator 300 to thereby activate a read start signal D_SYNC.

The pulse generator 300 receives the comparison output from the comparator 240 to thereby output the read start signal D_SYNC. The timing controller 400 receives the read start signal D_SYNC to thereby output a line address ADD_LINE and a read control signal LCRX.

An operation of the memory 500 is classified into a CPU write operation, a CPU read operation, and a panel read operation. The CPU write operation and the CPU write operation are performed by the CPU. The CPU writes or reads 18-bit pixel data at once. The 18-bit pixel data includes 6-bit red value R, 6-bit green value G, and 6-bit blue value B.

The memory 500 receives a chip select signal CSB, a read command RD and a write command WD outputted from a CPU, a write or a read address ADD_W/R, the line address ADD_LINE, and the read control signal LCRX. Further, the memory 500 receives and outputs a first and a second data DATA1 and DATA2.

Herein, the first data DATA1 is an 18-bit pixel data and read or written to the memory 500 in accordance with the read command RD and the write command WD. The second data DATA2 is used for driving the display panel. Therefore, second data DATA2 is 18-bit×240-pixel, i.e., 4320-bit line data. Further, the second data DATA2 is used for a read operation in accordance with a line address ADD_LINE and the read control signal LCRX. The line address ADD_LINE is a line number which will be read for driving the panel. For example, if the line address ADD_LINE is four, then the memory read is started from a fourth line of the frame.

The memory 500 is a kind of graphic RAM (GRAM). Generally, a static random access memory (SRAM) can be used instead of the GRAM.

An operation of the memory 500 is classified into a CPU write operation, a CPU read operation, and a panel read operation. The CPU write operation and the CPU write operation are performed by the CPU. The CPU writes or reads 18-bit pixel data at once. The 18-bit pixel data includes 6-bit red value R, 6-bit green value G, and 6-bit blue value B.

The panel read operation is a memory read operation for a panel driving. A line data which will be displayed on a predetermined line of the display panel is read from the memory 500 at once. In this embodiment, a size of the line data is 18-bit×240-pixel, i.e., 4320-bit.

For driving the display panel, the CPU write operation and the panel read operation are mainly performed. Meanwhile, the CPU read operation is performed only for testing the 2-filed TDC panel driver. Therefore, the memory read refers the panel read operation and the memory write refers the CPU write operation in this application.

Hereinafter, a driving operation of the 2-field TDC panel driver shown in FIG. 8 is explained

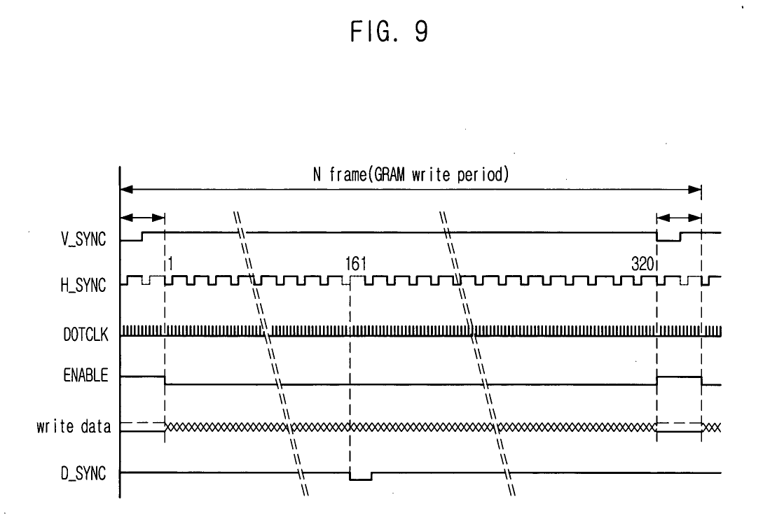

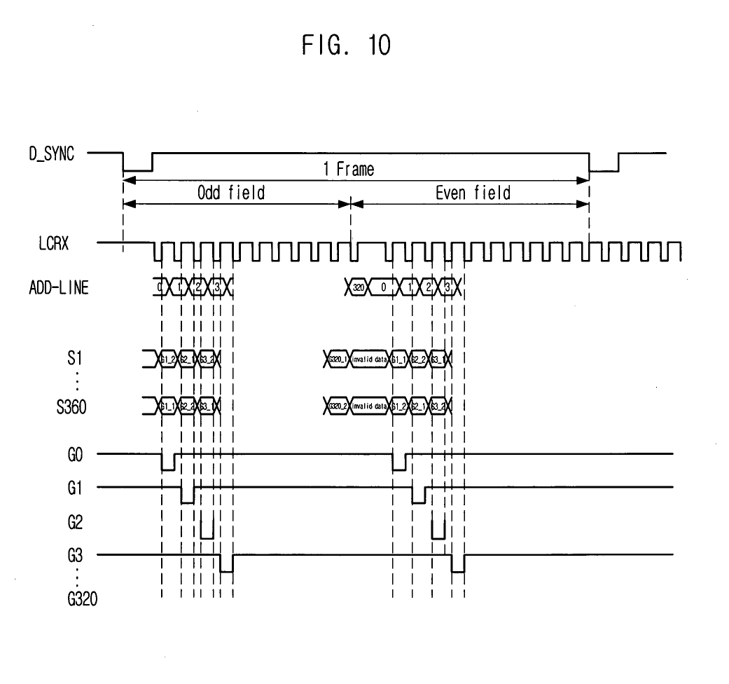

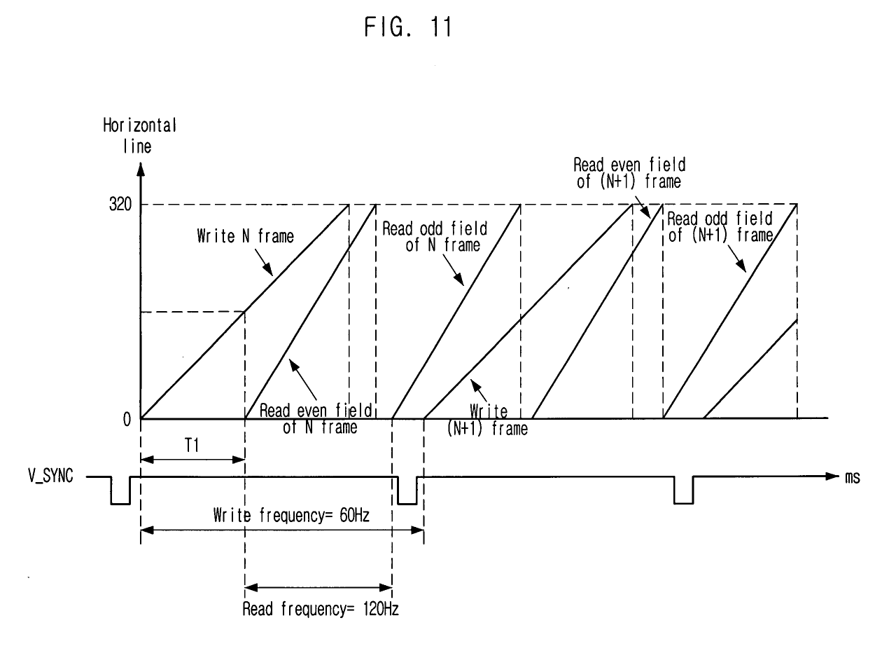

FIGS. 9 and 10 are diagrams demonstrating the operation of the 2-field TDC panel driver shown in FIG. 8.

As shown, after a write enable signal ENABLE becomes a logic level ‘L’ while the vertical synchronization signal V_SYNC is activated into a logic level ‘H’, the memory write is started to thereby write an N frame data to the memory 500. The memory write is performed in a unit of the pixel data of 18-bit. Because the 18-bit pixel data is written at the memory write, 240 numbers of the memory write are sequentially performed in order to write one line of the frame data while the write enable signal ENABLE is the logic level ‘L’, i.e., “0”.

Meanwhile, after the memory write is started, the address counter 100 counts the horizontal synchronization signal H_SYNC in order to determine which line of the frame data is written to the memory 500. When the counting value outputted from the address counter 100 becomes bigger than “161”, the read start signal D_SYNC is activated into a logic level ‘H’. Then, the data stored in the memory 500 written through the memory write is stated to be read and displayed in a unit of one line, i.e., 24 pixels, in response to the activation of the read start signal D_SYNC.

FIG. 11 is a diagram showing a relationship between the memory read line and memory write line where the memory read and the memory write timings shown in FIGS. 9 and 10 are applied to the 2-field TDC panel of the present invention.

As shown in FIG. 11, the memory read is started in a starting point D where a 161th line is written to the memory 500. In other words, the starting point D is where a 161th horizontal synchronization signal H_SYNC is occurred. Herein, the value “161” is corresponding to a half value of the total numbers of lines, i.e., “320”.

As above explained, in the abovementioned embodiment of the present invention, the frequency of the memory read is twice than that of the memory write. In other words, by controlling the starting point D of the memory read, the memory write line AN and the memory read line BN are not crossed each other. Therefore, after the read start signal D_SYNC is activated, the two memory reads are performed thereby preventing the occurrence of flickers. That is, by appropriately controlling the order value stored in the register 220, the flicker can be prevented on the 2-field TDC panel.

The present application contains subject matter related to Korean patent application No. 2004-72719, filed in the Korean Patent Office on Sep. 10, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A driving method for a time division controlled (TDC) panel driver, comprising the steps of:
(a) counting the number of a line corresponding to a predetermined resolution of a TDC panel to thereby output a count value;
(b) comparing the count value with a predetermined order value to thereby output a read start signal;
(c) generating a line address in response to the read start signal and outputting a memory read control signal; and
(d) performing a memory read and a memory write operations, wherein a start timing for the memory read operation is controlled by the memory read control signal.

2. The driving method as recited in claim 1, wherein the order value is a half value of the number of the line constituting the frame.

3. The driving method as recited in claim 2, wherein the step (b), the read start signal is activated when the count value is bigger than the order value.

4. The driving method as recited in claim 1, wherein a frequency for the memory read operation is twice than a frequency of the memory write operation.

5. A time division controlled (TDC) panel driver, comprising:
an address counter for counting the number of a line corresponding to a predetermined resolution of a TDC panel to thereby output a count value;
a timing generating block for comparing the count value with a predetermined order value to thereby output a read start signal;
a timing controller for generating a line address in response to the read start signal and outputting a memory read control signal; and
a memory for performing a memory read and a memory write operations, wherein a start timing for the memory read operation of the memory is controlled by the memory read control signal.

6. The TDC panel driver as recited in claim 5, wherein the order value is a half value of the number of the line constituting the frame.

7. The TDC panel driver as recited in claim 6, wherein the timing generating block activates the read start signal when the count value is higher than the order value.

8. The TDC panel driver as recited in claim 7, wherein the timing generating block includes:
a timing generator for comparing the count value and the order value to thereby output a first output; and
a pulse generator for outputting the read start signal in response to the first output.

9. The TDC panel driver as recited in claim 8, wherein the timing generator includes:
a register for storing the order value determining the start timing of the memory read operation; and
a comparator for comparing the count value and the order value and for outputting an comparing output when the count value is bigger than the order value, wherein the comparing output activates the read start signal.

10. The TDC panel driver as recited in claim 5, wherein the TDC panel is a 2-field TDC panel which frame is divided into two fields, i.e., an even field and an odd field.

11. The TDC panel driver as recited in claim 10, wherein a frequency for the memory read operation is twice than a frequency of the memory write operation.

12. A time division controlled (TDC) display system, comprising:
a panel having a plurality of pixels, each having at least two color sub-pixels among R, G, B-type sub-pixels, for receiving a data in response to a data control signal; and
a panel driver for reducing a flicker by controlling memory read and memory write timings to thereby output the data and the data control signal into the panel.

13. The TDC display system as recited in claim 12, wherein the panel driver includes:
an address counter for counting a pixel address of a line corresponding to a predetermined resolution of the panel to thereby output a counting value;
a timing generating block for comparing the counting value with a predetermined order value to thereby output a read start signal;
a timing controller for generating a line address in response to the read start signal and outputting the data control signal; and
a memory for performing a memory read and a memory write operations, wherein a start timing for the memory read operation of the memory is controlled by the data control signal.

14. The TDC display system as recited in claim 13, wherein the order value is a half value of the number of the line constituting the frame.

15. The TDC display system as recited in claim 14, wherein the timing generating block activates the read start signal when the counting value is higher than the order value.

16. The TDC display system as recited in claim 15, wherein the timing generating block includes:
a timing generator for comparing the counting value with the order value to thereby output a first output; and
a pulse generator for outputting the read start signal in response to the first output.

17. The TDC display system as recited in claim 16, wherein the timing generator includes:
a register for storing the order value determining the start timing of the memory read operation; and
a comparator for comparing the counting value with the order value and for outputting an comparing output when the counting value is bigger than the order value, wherein the comparing output activates the read start signal.

18. The TDC display system as recited in claim 12, wherein the panel is a 2-field TDC panel which frame is divided into two fields, i.e., an even field and an odd field.

19. The TDC display system as recited in claim 18, wherein a frequency for the memory read operation is twice than a frequency of the memory write operation.
